(19) United States
(12) Patent Application Publication
(10) Pub. No.: US 2018/0195693 A1
(43) Pub. Date: Jul. 12, 2018

(54) LIGHT SOURCE DEVICE, ILLUMINATION APPARATUS, AND PROJECTOR

(71) Applicant: SONY CORPORATION, TOKYO (JP)

(72) Inventor: HIROYUKI YANAGISAWA, KANAGAWA (JP)

(21) Appl. No.: 15/569,471

(22) PCT Filed: Apr. 19, 2016
(86) PCT No.: PCT/JP2016/062322

§ 371 Date: Oct. 26, 2017

(30) Foreign Application Priority Data
May 15, 2015 (JP) 2015-100390

(51) Int. Cl. F21V 13/02; F21V 9/32; F21V 5/00; F21V 5/04; G03B 21/20; H04N 5/74

(52) U.S. Cl. CPC F21V 13/02; F21V 9/32; F21V 5/004; H04N 5/74; F21V 5/045; F21V 5/043; G03B 21/2093; F21V 5/007

(57) ABSTRACT

Provided is an illumination apparatus by which illumination light is obtained efficiently. The illumination apparatus includes a light source device including a light source section that emits excitation light and a light emitting element that has a surface to be irradiated with the excitation light, in which light emitting element is excited by the irradiation of the surface with the excitation light and thereby emits fluorescence from the surface, and an illumination optical system that modulates the fluorescence derived from the light source device. The density distribution, on the surface, of the excitation light has a shape that follows a shape of a distribution of light-introduction efficiency of the illumination optical system.

### TECHNICAL FIELD

The disclosure relates to a light source device having a light emitting element that emits fluorescence, and an illumination apparatus and a projector provided with the light source device.

### BACKGROUND ART

A projection type image display device, i.e., a projector, has been used so far that projects a picture screen of a personal computer, a video picture, and so forth onto a screen. Although a high-luminance discharge lamp has been the mainstream before as a light source device in the projector, the ones using semiconductor light emitting elements such as a light emitting diode (LED), a laser diode (LD), and an organic EL have been proposed recently.

As such a light source device, a light source device has been proposed that extracts white light as fluorescence by irradiating a phosphor with light derived from the light emitting diode or the laser (see, for example, Patent Literature 1). The light source device in Patent Literature 1 is provided with a light source that is for excitation light and outputs the excitation light (blue light) that excites the phosphor and the phosphor that receives the excitation light and emits light of a wavelength different from that of the excitation light.

### CITATION LIST

### Patent Literature

Patent Literature 1: Japanese Unexamined Patent Application Publication No. 2013-92752 specification

### SUMMARY OF THE INVENTION

However, a density distribution of excitation light on an irradiated surface of a phosphor has a Gaussian shape that indicates a maximum intensity at the center or has a so-called top-hat shape. Accordingly, it has not been possible to obtain illumination light efficiently.

Therefore, it is desirable to provide an illumination apparatus by which illumination light is obtained efficiently, and a projector provided with the illumination apparatus and a light source device that is favorably used in these illumination apparatus and projector.

A light source device according to one embodiment of the disclosure includes: a light source section that emits excitation light; a light emitting element that has a surface to be irradiated with the excitation light, in which the light emitting element is excited by the irradiation of the surface with the excitation light and thereby emits fluorescence from the surface; and a light ray control element that controls a light density distribution of the excitation light with which the surface of the light emitting element is to be irradiated, to cause the light density distribution to have a substantially truncated-pyramid shape that includes a central region and a peripheral region, in which the central region has a flat light density, and the peripheral region surrounds the central region and has a light density that is monotonically decreased as going away from the central region.

In the light source device according to one embodiment of the disclosure, the light density distribution of the excitation light with which the surface of the light emitting element is to be irradiated is controlled to become a trapezoidal shape by the light ray control element. Accordingly, in a case where the light source device is combined with, for example, an illumination optical system, the illumination light is more efficiently obtained.

An illumination apparatus according to one embodiment of the disclosure includes: a light source device including a light source section that emits excitation light and a light emitting element that has a surface to be irradiated with the excitation light, in which the light emitting element is excited by the irradiation of the surface with the excitation light and thereby emits fluorescence from the surface; and an illumination optical system that modulates the fluorescence derived from the light source device. Here, a density distribution, on the surface, of the excitation light has a shape that follows a shape of a distribution of light-introduction efficiency of the illumination optical system. In addition, a projector according to one embodiment of the disclosure includes the illumination apparatus according to one embodiment of the disclosure.

In the illumination apparatus and the projector according to one embodiment of the disclosure, the density distribution, on the surface, of the excitation light has the shape that follows the shape of the distribution of light-introduction efficiency of the illumination optical system. Accordingly, the illumination light is more efficiently obtained.

According to the light source device, the illumination apparatus and the projector in one embodiment of the disclosure, it is possible to obtain the illumination light that is higher in luminance while suppressing a light intensity of the excitation light.

Incidentally, the effect of the disclosure is not limited to this and may be any of effects which will be described in the following.

### BRIEF DESCRIPTION OF THE DRAWINGS

FIG. 1 is a schematic diagram illustrating a light source device according to one embodiment of the disclosure.

FIG. 2 is a plan view illustrating a light emitting element illustrated in FIG. 1.

FIG. 3A is a characteristic diagram illustrating a light density distribution on a surface of the light emitting element of the light source device illustrated in FIG. 1.

FIG. 3B is another characteristic diagram illustrating the light density distribution on the surface of the light emitting element of the light source device illustrated in FIG. 1.

FIG. 4 is a schematic diagram illustrating a projector according to one embodiment of the disclosure.

FIG. 5 is a characteristic diagram illustrating light use efficiency according to examples.

### DESCRIPTION OF EMBODIMENTS

In the following, an embodiment of the disclosure will be described in detail with reference to the drawings. Incidentally, description will be made in the following order.

1. Embodiment (Light Source Device)

2. Application Examples (Illumination Apparatus and Projector)

3. Examples

### 1. EMBODIMENT

[Configuration of Light Source Device 10]

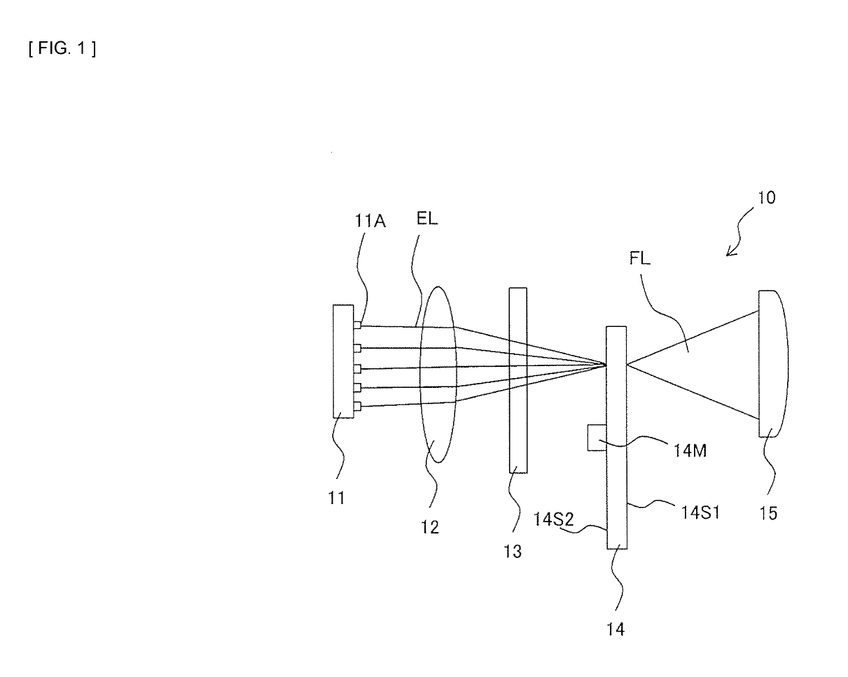

FIG. 1 illustrates an outline configuration of the light source device 10 according to one embodiment of the disclosure. The light source device 10 has a light source section 11 including a plurality of light sources, a light condensing section 12, a light ray control element 13, a light emitting element 14, and a lens 15.

The light source section 11 emits excitation light EL toward the light condensing section 12, and is the one in which a plurality of light sources 11A are arrayed. The plurality of light sources 11A are, for example, semiconductor laser elements that oscillate blue laser light as the excitation light EL.

The light condensing section 12 condenses the excitation light EL emitted from the light source section 11 on a surface 14S (described later) of a phosphor of the light emitting element 14.

The light ray control element 13 controls a light density distribution of the excitation light EL with which the surface 14S of the light emitting element 14 is to be irradiated, and is configured by, for example, a micro-lens array.

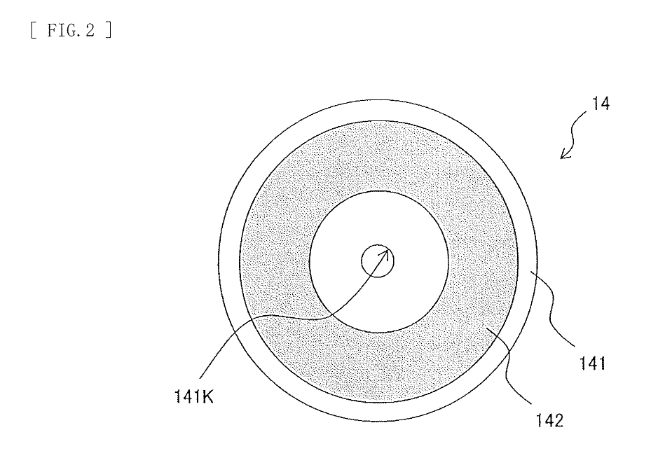

The light emitting element 14 is also called a phosphor wheel, and is the one in which a phosphor layer 142 is formed on a front surface 14S1 of a base member 141 configured by a thin plate having a circular planar shape, for example, as illustrated in FIG. 2. Incidentally, an opening 141K is provided in the center of the base member 141. A rotary shaft (not illustrated) of a motor 14M is inserted into the opening 141K and is fixed therein (FIG. 1). The light emitting element 14 is a so-called transmission type light emitting element.

The base member 141 functions as a substrate that supports the phosphor layer 142 and also functions as a heat dissipation member. The base member 141 is configured by a transparent material, and has a property of transmitting the excitation light EL with which a back surface 14S2 on the opposite side of the front surface 14S1 is to be irradiated. Specific examples of constituent materials of the base member 141 include quartz, glass, sapphire, crystal, and YAG. In addition, a dichroic mirror that transmits the excitation light EL and reflects fluorescence FL may be provided on the front surface 14S1 so as to increase luminous efficiency of the light emitting element 14.

The phosphor layer 142 contains a plurality of phosphor particles (not illustrated) that are mutually coupled by, for example, a binder (not illustrated). The phosphor particle is a particulate phosphor that absorbs the excitation light EL (for example, laser light) applied from the outside and thereby emits the fluorescence FL. A fluorescent substance that is excited by blue laser light having a wavelength in a blue wavelength region (for example, 400 nm to 470 nm) and emits yellow fluorescence (light of a wavelength region between a red wavelength region and a green wavelength region) is contained in, for example, the phosphor particle. For example, a YAG (Yttrium-Aluminum-Garnet)-based material is used as such a fluorescent sub stance.

In the light emitting element 14, when the excitation light EL from the light source section 11 is transmitted through the base member 141 and the phosphor layer 142 is irradiated with the excitation light EL, the phosphor particles contained in the phosphor layer 142 are excited and the fluorescence FL of a wavelength different from that of the excitation light EL is emitted from the phosphor particles.

The lens 15 is an optical system that introduces the fluorescence FL from the light emitting element 14 and radiate the introduced fluorescence FL toward the outside (for example, an illumination optical system 20 which will be described later).

[Workings and Effects of Light Source Device 10]

In the light source device 10, first, the excitation light EL (for example, the blue laser light) is oscillated from each of the light sources 11A of the light source section 11 and travels toward the light emitting element 14. The excitation light EL from the light source section 11 is condensed by the light condensing section 12 and thereafter enters the light ray control element 13.

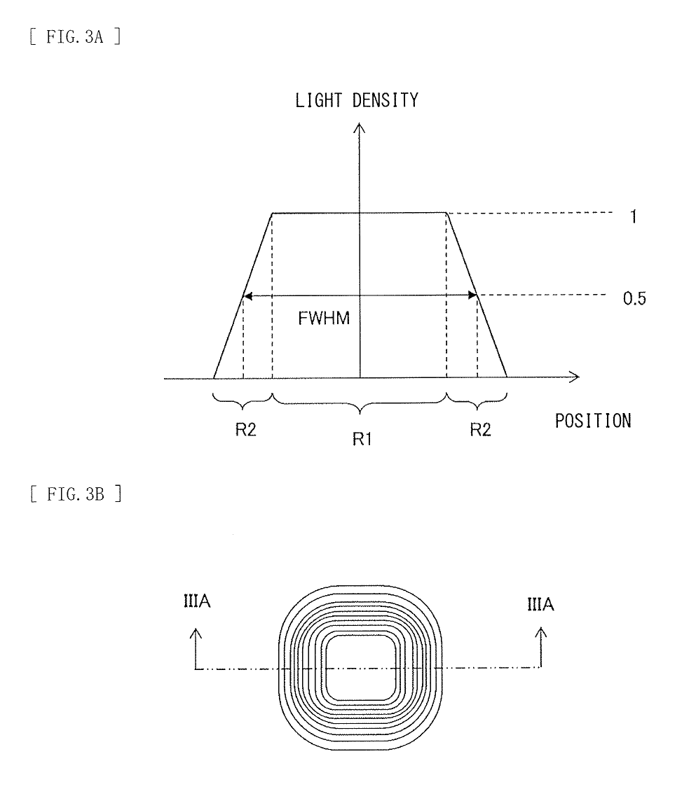

In the light ray control element 13, a control is made such that the light density distribution of the excitation light EL with which the front surface 14S1 of the light emitting element 14 is irradiated becomes a desired shape. Here, the light ray control element 13 controls the light density distribution of the excitation light EL on the front surface 14S1 so as to become a substantially truncated-pyramid shape that includes a central region R1 and a peripheral region R2 as illustrated in FIG. 3A and FIG. 3B, for example. The central region R1 has a flat light density. The peripheral region R2 surrounds the central region R1 and has a light density that is monotonically decreased as going away from the central region R1. Incidentally, FIG. 3B illustrates the light density distribution of the excitation light EL on the front surface 14S1 and each line is an isoline indicating mutually equal light densities. FIG. 3A illustrates a light density distribution of the excitation light EL in a cross-section taken along the IIIA-IIIA line in FIG. 3B. In FIG. 3A, the horizontal axis indicates a position (where a center position is 0) on the surface 14S and the vertical axis indicates a light density (where the light density at the center position is 1). It is desirable that a slope of a change in the light density of the excitation light EL in the peripheral region R2 be larger than 0 and smaller than 0.4 when a half-value width of the light density distribution as a whole of the excitation light EL is 1.

The light emitting element 14 involves the excitation of the phosphor particles contained in the phosphor layer 142 through the irradiation of the phosphor layer 142 with the excitation light EL derived from the light source section 11, and thus emits the fluorescence FL of the wavelength different from that of the excitation light EL, for example, to the side opposite to the light source section 11. The fluorescence FL emitted from the light emitting element 14 is introduced into the lens 15 to be radiated to the outside.

In the light source device 10 according to the present embodiment, the control is thus made by the light ray control element 13 such that the light density distribution of the excitation light EL with which the front surface 14S1 of the light emitting element 14 is irradiated becomes the substantially truncated-pyramid shape. Therefore, in the light source device, the illumination light is obtained more efficiently. This is attributed to occurrence of vignetting on a peripheral edge portion of the lens 15, since the aperture size of the lens 15 that introduces the fluorescence FL emitted from the light emitting element 14 is finite. Therefore, the shape of the distribution of the light-introduction efficiency on the lens 15 also becomes the substantially truncated-pyramid shape. By bringing the light density distribution of the excitation light EL close to the shape of the distribution of the light-introduction efficiency of the lens 15, it is possible to reduce an amount of light that is blocked on the peripheral edge portion of the lens 15, and to efficiently introduce the fluorescence FL by the lens 15 consequently.

### 2. APPLICATION EXAMPLE (ILLUMINATION APPARATUS AND PROJECTOR)

[Configurations of Illumination Apparatus and Projector]

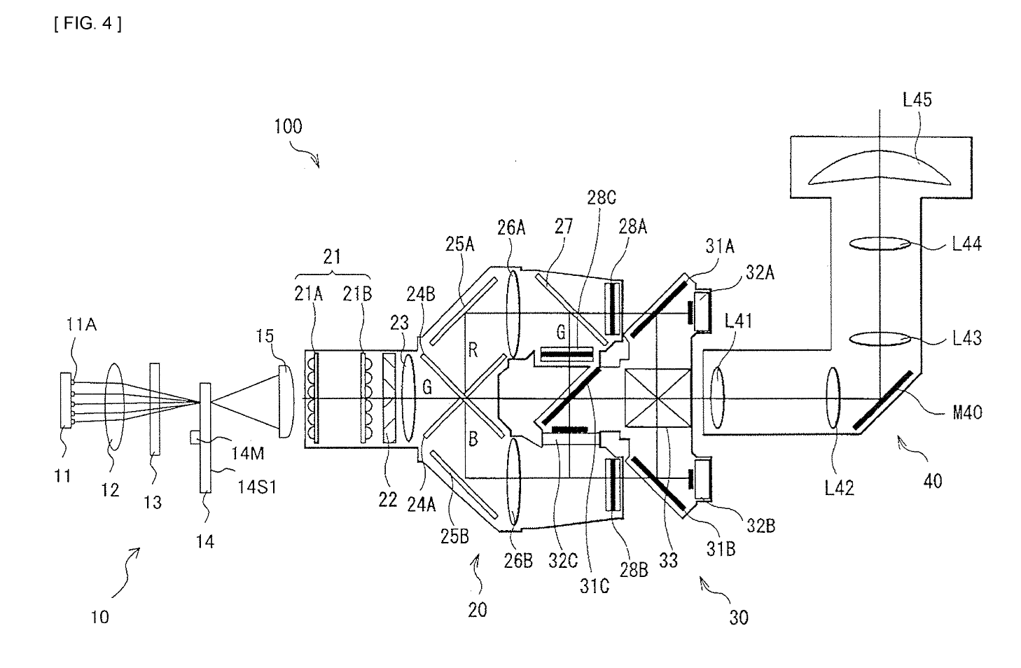

Next, an illumination apparatus and a projector 100 provided with the light source device 10 will be described with reference to FIG. 4. FIG. 4 is a schematic diagram illustrating the overall configuration of the projector 100 provided with the light source device 10. Incidentally, in the following, description will be made by exemplifying a reflection-type-3LCD-system projector that performs light modulation by a reflection type liquid crystal panel (LCD). However, light emitting elements 1 or 1A is also applicable to a projector in which a transmission type liquid crystal panel, a digital micro-mirror device (DMD), or the like is used instead of the reflection type liquid crystal panel.

Referring to FIG. 4, the projector 100 is provided with the light source device 10, the illumination optical system 20, an image forming section 30, and a projection optical system 40 in order. Here, the light source device 10 and the illumination optical system 20 correspond to an illumination apparatus of the disclosure.

The illumination optical system 20 has, for example, from a position close to the light source device, fly-eye lenses 21 (21A, 21B), a polarized light conversion element 22, a lens 23, dichroic mirrors 24A and 24B, reflection mirrors 25A and 25B, lenses 26A and 26B, a dichroic mirror 27, and polarizing plates 28A to 28C.

The fly-eye lenses 21 (21A and 21B) allow for uniformity of an illuminance distribution of white light from the lens 15 of the light source device 10. The polarized light conversion element 22 functions so as to arrange a polarization axis of incident light in a predetermined direction and converts, for example, light other than P-polarized light into the P-polarized light. The lens 23 condenses light from the polarized light conversion element 22 toward the dichroic mirrors 24A and 24B. The dichroic mirrors 24A and 24B selectively reflect light of a predetermined wavelength region and cause light of other wavelength regions to be transmitted therethrough selectively. For example, the dichroic mirror 24A reflects mainly red light in a direction of the reflection mirror 25A. In addition, the dichroic mirror 24B reflects mainly blue light in a direction of the reflection mirror 25B. Accordingly, mainly green light is transmitted through both of the dichroic mirrors 24A and 24B and travels toward a reflection type polarizing plate 31C (described later) of the image forming section 30. The reflection mirror 25A reflects light (mainly the red light) derived from the dichroic mirror 24A toward the lens 26A and the reflection mirror 25B reflects light (mainly the blue light) derived from the dichroic mirror 24B toward the lens 26B. The lens 26A causes light (mainly, the red light) derived from the reflection mirror 25A to be transmitted therethrough and condenses the light to the dichroic mirror 27. The lens 26B causes light (mainly the blue light) derived from the reflection mirror 25B to be transmitted therethrough, and condenses the light to the dichroic mirror 27. The dichroic mirror 27 selectively reflects the green light and causes the light of other wavelength regions to be transmitted therethrough selectively. Here, the dichroic mirror 27 causes a red light component in the light derived from the lens 26A to be transmitted therethrough. In a case where a green light component is contained in the light derived from the lens 26A, the dichroic mirror 27 reflects the green light component toward the polarizing plate 28C. The polarizing plates 28A to 28C include polarizers each having a polarization axis in a predetermined direction. For example, in a case where light is converted into P-polarized light by the polarized light conversion element 22, the polarizing plates 28A to 28C cause the P-polarized light to be transmitted therethrough and reflect S-polarized light.

The image forming section 30 has reflection type polarizing plates 31A to 31C, reflection type liquid crystal panels 32A to 32C, and a dichroic prism 33.

The reflection type polarizing plates 31A to 31C each cause light (for example, the P-polarized light) of a polarization axis that is the same as the polarization axis of the polarized light derived from each of the polarizing plates 28A to 28C to be transmitted therethrough, and reflect the light (the S-polarized light) of another polarization axis. Specifically, the reflection type polarizing plate 31A causes the P-polarized red light derived from the polarizing plate 28A to be transmitted in a direction of the reflection type liquid crystal panel 32A. The reflection type polarizing plate 31B causes the P-polarized blue light derived from the polarizing plate 28B to be transmitted in a direction of the reflection type liquid crystal panel 32B. The reflection type polarizing plate 31C causes the P-polarized green light derived from the polarizing plate 28C to be transmitted in a direction of the reflection type liquid crystal panel 32C. In addition, the P-polarized green light that has been transmitted through both of the dichroic mirrors 24A and 24B and entered the reflection type polarizing plate 31C is transmitted through the reflection type polarizing plate 31C and enters the dichroic prism 33 as it is. Further, the reflection type polarizing plate 31A reflects the S-polarized red light derived from the reflection type liquid crystal panel 32A and makes the light enter the dichroic prism 33. The reflection type polarizing plate 31B reflects the S-polarized blue light derived from the reflection type liquid crystal panel 32B and makes the light enter the dichroic prism 33. The reflection type polarizing plate 31C reflects the S-polarized green light derived from the reflection type liquid crystal panel 32C and makes the light enter the dichroic prism 33.

The reflection type liquid crystal panels 32A to 32C perform spatial modulation of the red light, the blue light, and the green light, respectively.

The dichroic prism 33 synthesizes together the entered red light, blue light, and green light, and outputs synthesized light toward the projection optical system 40.

The projection optical system 40 has lenses L41 to L45 and a mirror M40. The projection optical system 40 enlarges outgoing light derived from the image forming section 30, and projects the light onto, for example, a screen (not illustrated).

[Operations of Light Source Device and Projector]

Next, an operation of the projector 100 including the light source device 10 will be described with reference to FIG. 3 and FIG. 4.

First, in the light source device 10, the motor 14M is driven to rotate the light emitting element 14. Thereafter, the excitation light EL that is the blue light is oscillated from the light source 11A of the light source section 11.

The excitation light EL is oscillated from the light source 11A, following which the excitation light EL is transmitted through the light condensing section 12 and the light ray control element 13 in order to irradiate the phosphor layer 142 of the light emitting element 14 thereafter. The phosphor layer 142 of the light emitting element 14 absorbs portion of the excitation light EL, thus converting the portion into the fluorescence FL that is the yellow light and emitting the fluorescence FL toward the lens 15. The fluorescence FL is transmitted through the lens 15 and travels toward the illumination optical system 20. On this occasion, the light emitting element 14 causes the remaining excitation light EL not absorbed by the phosphor layer 142 to be transmitted toward the lens 15. The excitation light EL that has been transmitted through the light emitting element 14 is also transmitted through the lens 15 and travels toward the illumination optical system 20.

The light source device 10 makes the white light, in which the fluorescence FL that is the yellow light and the excitation light EL that is the blue light are synthesized together, enter the illumination optical system 20.

The white light from the light source device 10 is sequentially transmitted through the fly-eye lenses 21 (21A and 21B), the polarized light conversion element 22, and the lens 23, and thereafter reaches the dichroic mirrors 24A and 24B.

Mainly the red light is reflected by the dichroic mirror 24A and the red light is sequentially transmitted through the reflection mirror 25A, the lens 26A, the dichroic mirror 27, the polarizing plate 28A, and the reflection type polarizing plate 31A, and reaches the reflection type liquid crystal panel 32A. Further, the red light is spatially modulated by the reflection type liquid crystal panel 32A, following which the spatially-modulated red light is reflected by the reflection type polarizing plate 31A and enters the dichroic prism 33. Incidentally, in a case where the green light component is contained in the light that has been reflected by the dichroic mirror 24A to the reflection mirror 25A, the green light component is reflected by the dichroic mirror 27 to be sequentially transmitted through the polarizing plate 28C and the reflection type polarizing plate 31C and reaches the reflection type liquid crystal panel 32C. Mainly the blue light is reflected by the dichroic mirror 24B and enters the dichroic prism 33 through a similar process. The green light that has been transmitted through the dichroic mirrors 24A and 24B also enters the dichroic prism 33.

The red light, the blue light and the green light that have entered the dichroic prism 33 are synthesized together and thereafter outputted toward the projection optical system 40 as picture light. The projection optical system 40 enlarges the picture light derived from the image forming section 30 and projects the light onto, for example, the screen (not illustrated).

The illumination apparatus according to the disclosure has the light source device 10 as described above. Thus, the density distribution of the excitation light EL on the front surface 14S1 has the shape that follows the shape of the distribution of the light-introduction efficiency of the illumination optical system 20, i.e., has the substantially truncated-pyramid shape. Therefore, an energy loss when the fluorescence FL derived from the light source device 10 is introduced into the illumination optical system 20 is little. Thus, the illumination light is obtained more efficiently. Accordingly, it is possible for the projector of the disclosure to exhibit excellent display performance while suppressing the light intensity of the excitation light EF. Incidentally, this is, the distribution of the light-introduction efficiency of the illumination optical system 20, which has the substantially truncated-pyramid shape, is attributed to vignetting in the opening of the fly-eye lenses 21 of the illumination optical system 20 similarly to the vignetting that occurs on the peripheral edge portion of the lens 15 of the light source device 10. Further, vignetting in the opening of the polarized light conversion element 22 that occurs due to an aberration of the fly-eye lenses 21, vignetting in effective openings in the reflection type liquid crystal panels 32A to 32C and so forth also influence the shape of the light-introduction efficiency of the illumination optical system 20.

### EXAMPLES

### Examples 1-1 to 1-5

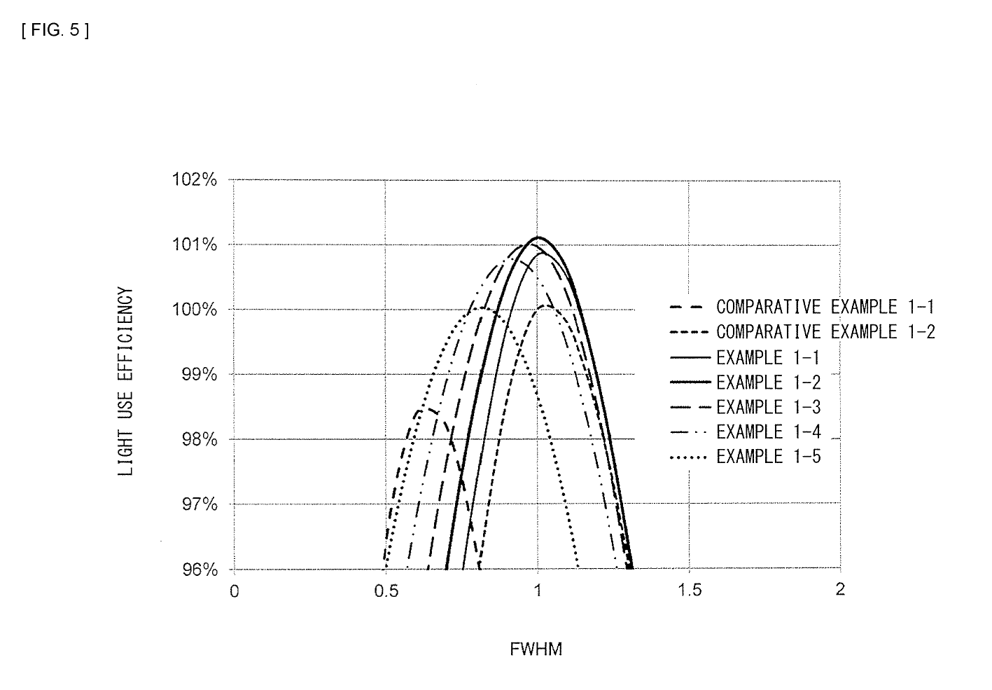

Samples of the light source device 10 described in the above-mentioned embodiment were fabricated. Light use efficiency, when the slope of the change in the light density of the excitation light EL in the peripheral region R2 was changed in a range from 0.1 to 0.4 (where, the half-value width of the light density distribution as a whole of the excitation light is 1), was measured for each of the samples. A result thereof is illustrated in FIG. 5. Here, the light use efficiency refers to a ratio of energy of the fluorescence FL outputted from the light emitting element 14 to energy of the excitation light EL with which the light emitting element 14 is irradiated. The slope was set to 0.1 in the example 1-1, the slope was set to 0.2 in the example 1-2, the slope was set to 0.3 in the example 1-3, the slope was set to 0.4 in the example 1-4, and the slop was set to 0.45 in the example 1-5. Incidentally, in FIG. 5, the horizontal axis indicates the half-value width of the light intensity distribution as a whole of the excitation light EL and the vertical axis indicates the light use efficiency.

### Comparative Example 1-1

Samples were fabricated similarly to the above-mentioned examples 1-1 to 1-5, except that the excitation light having the light density distribution of a Gaussian distribution shape was applied to the light emitting element without traveling through the light ray control element 13. The light use efficiencies of such samples were obtained. A result thereof is illustrated together in FIG. 5 as well.

### Comparative Example 1-2

Samples were fabricated similarly to the above-mentioned examples 1-1 to 1-5, except that the slope of the change in the light density of the excitation light EL in the peripheral region R2 was set to 0. The light use efficiencies of such samples were obtained. A result thereof is illustrated together in FIG. 5 as well.

As illustrated in FIG. 5, it was found that the examples 1-1 to 1-5 are able to obtain the light use efficiencies higher than those of the comparative examples 1-1 and 1-2.

In the foregoing, although the disclosure has been described by referring to the embodiment, the disclosure is not limited to the above-described embodiment, and various modifications thereof are possible. For example, the material, arrangement and so forth of each constituent element described in the above-mentioned embodiment are mere examples and are not limited thereto. Other materials and arrangement may also be employed.

In addition, in the above-described embodiment, description has been made by exemplifying the so-called transmission type light emitting element. However, the disclosure is not limited thereto. For example, a reflection type light emitting element may also be used. In this case, the base member 141 is made of an inorganic material such as a metal material and a ceramics material. Specifically, as the metal materials that configure the base member 141, for example, simple-substance metals such as Mo (molybdenum), W (tungsten), Co (cobalt), Cr (chrome), Pt (platinum), Ta (tantalum), Li (lithium), Zr (zirconium), Ru (ruthenium), Rh (rhodium), and Pd (palladium) and alloys containing one or more kinds thereof may be given. Alternatively, it is also possible to use, as the metal materials that configure the base member 141, alloys such as CuW in which the content of W (tungsten) is 80 atom % or higher and CuMo in which the content of Mo (molybdenum) is 40 atom % or higher. In addition, as the ceramics materials, the ones that contain, for example, SiC (silicon carbide), AlN (aluminum nitride), BeO (beryllium oxide), a composite material of Si and SiC, or a composite material of SiC and Al (where the one in which the content of SiC is 50% or higher) may be given. Further, quartz may be also used besides crystalline materials such as simple-substance Si, SiC, diamond, and sapphire. In addition, a reflection layer may be provided between the base member 141 and the phosphor layer 142. Such a reflection layer is formed by, for example, a metal film that contains metal elements such as Al (aluminum), Ag (silver), and Ti (titanium), besides a dielectric multilayer film, for example. By providing the reflection layer, it is possible to cause the excitation light EL (for example, the laser light) applied from the outside and the fluorescence FL derived from the phosphor layer 142 to be reflected and thereby to increase the luminous efficiency of the light emitting element 14.

In addition, in the above-described embodiment, the blue laser as the excitation light EL is applied in the light source device 10 to extract the yellow fluorescence from the light emitting element 14, and the extracted yellow fluorescence is synthesized with the blue light to obtain the white light. The technology, however, is not limited thereto.

Further, although description has been made by specifically referring to the configurations of the light source device 10 and the projector 100 in the above-described embodiment, it may not be necessary to provide all of the constitutional elements and other constitutional elements may be provided.

In addition, although in the above-described embodiment, description has been made by exemplifying the micro-lens array as the light ray control element, the disclosure is not limited thereto. For example, a rod integrator, a diffraction element in which a fine periodic pattern having a lens action is formed, or a diffusion plate (the one in which an irregular structure is formed on a surface of a glass plate or a transparent resin plate so as to appropriately diffuse incident light) may be used as the light ray control element. In addition, although the fly-eye lenses are used in the illumination optical system, uniformity of the illumination light may be achieved by using the rod integrator also in the illumination optical system in the disclosure.

Incidentally, the effects described in the specification are merely illustrative and are not limited to the description thereof and there may be other effects. In addition, the technology may also have such configurations as follows.

(1)

A light source device including:

a light source section that emits excitation light;

a light emitting element that has a surface to be irradiated with the excitation light, the light emitting element being excited by the irradiation of the surface with the excitation light and thereby emitting fluorescence from the surface; and

a light ray control element that controls a light density distribution of the excitation light with which the surface of the light emitting element is to be irradiated, to cause the light density distribution to have a substantially truncated-pyramid shape that includes a central region and a peripheral region, the central region having a flat light density, the peripheral region surrounding the central region and having a light density that is monotonically decreased as going away from the central region.

(2)

The light source device according to (1), in which a slope of a change in the light density of the excitation light in the peripheral region is larger than 0 and smaller than 0.4 where a half-value width is 1.

(3)

The light source device according to (1) or (2), in which the light ray control element includes one of a micro-lens array, a rod integrator, a diffraction element, and a diffusion plate.

(4)

An illumination apparatus including:

a light source device including a light source section that emits excitation light and a light emitting element that has a surface to be irradiated with the excitation light, the light emitting element being excited by the irradiation of the surface with the excitation light and thereby emitting fluorescence from the surface; and

an illumination optical system that modulates the fluorescence derived from the light source device,

a density distribution, on the surface, of the excitation light having a shape that follows a shape of a distribution of light-introduction efficiency of the illumination optical system.

(5)

A projector including:

an illumination apparatus;

a light modulation element that modulates light outputted from the illumination apparatus; and

a projection optical system that projects the light derived from the light modulation element,

the illumination apparatus including
a light source device including a light source section that emits excitation light and a light emitting element that has a surface to be irradiated with the excitation light, the light emitting element being excited by the irradiation of the surface with the excitation light and thereby emitting fluorescence from the surface, and
an illumination optical system that modulates the fluorescence derived from the light source device,

a density distribution, on the surface, of the excitation light having a shape that follows a shape of a distribution of light-introduction efficiency of the illumination optical system.

The present application is based on and claims priority from Japanese Patent Application No. 2015-100390 filed with the Japan Patent Office on May 15, 2015, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A light source device comprising:
a light source section that emits excitation light;
a light emitting element that has a surface to be irradiated with the excitation light, the light emitting element being excited by the irradiation of the surface with the excitation light and thereby emitting fluorescence from the surface; and
a light ray control element that controls a light density distribution of the excitation light with which the surface of the light emitting element is to be irradiated, to cause the light density distribution to have a substantially truncated-pyramid shape that includes a central region and a peripheral region, the central region having a flat light density, the peripheral region surrounding the central region and having a light density that is monotonically decreased as going away from the central region.

2. The light source device according to claim 1, wherein a slope of a change in the light density of the excitation light in the peripheral region is larger than 0 and smaller than 0.4 where a half-value width is 1.

3. The light source device according to claim 1, wherein the light ray control element comprises one of a micro-lens array, a rod integrator, a diffraction element, and a diffusion plate.

4. An illumination apparatus comprising:
a light source device including a light source section that emits excitation light and a light emitting element that has a surface to be irradiated with the excitation light, the light emitting element being excited by the irradiation of the surface with the excitation light and thereby emitting fluorescence from the surface; and
an illumination optical system that modulates the fluorescence derived from the light source device,
a density distribution, on the surface, of the excitation light having a shape that follows a shape of a distribution of light-introduction efficiency of the illumination optical system.

5. A projector comprising:
an illumination apparatus;
a light modulation element that modulates light outputted from the illumination apparatus; and
a projection optical system that projects the light derived from the light modulation element,
the illumination apparatus including
a light source device including a light source section that emits excitation light and a light emitting element that has a surface to be irradiated with the excitation light, the light emitting element being excited by the irradiation of the surface with the excitation light and thereby emitting fluorescence from the surface, and
an illumination optical system that modulates the fluorescence derived from the light source device,
a density distribution, on the surface, of the excitation light having a shape that follows a shape of a distribution of light-introduction efficiency of the illumination optical system.
